(19) United States
(12) Patent Application Publication
(10) Pub. No.: US 2007/0027727 A1
(43) Pub. Date: Feb. 1, 2007

(54) Method for healthcare financial planning

(75) Inventor: Tom Cochrane, San Francisco, CA (US)

Correspondence Address: William L, Botjer, PO Box 478, Center Moriches, NY, 11934, US

(73) Assignee: HEALTHIA, INC.

(21) Appl. No.: 11/491,805

(22) Filed: Jul. 24, 2006

Related U.S. Application Data
(60) Provisional application No. 60/702,297, filed on Jul. 26, 2005.

(51) Int. Cl. G06Q 40/00

(52) U.S. Cl. 705/4

(57) ABSTRACT

A method, a system and a computer program product that includes an interactive interface for healthcare financial planning. Healthcare financial planning is performed for a plurality of health plan options. The invention enables a user to compare various health plan options. The user may be required to input data, which is used to project health plan liabilities for a pre-determined time period. The projections are based on a known health claim probability distribution. Health plan liabilities are transformed into health plan costs. The projection and transformation of health plan liabilities are based on age, gender, family dependent status, industry classification and zip code data.

### CROSS REFERENCE TO RELATED APPLICATIONS

This Application Claims Priority of U.S. Provisional Patent Application Ser. No. 60/702,297 filed Jul. 26, 2005.

### BACKGROUND OF THE INVENTION

The invention relates generally to financial planning. More specifically, the invention relates to selection and comparison of health plan options.

Individuals need to invest a sizeable proportion of their income for their healthcare expenses. These expenses may be incurred in the form of healthcare insurance premiums. Further, for employees, a portion of their expenses are borne by their employers. Health insurance premiums burden employees and employers with high healthcare costs.

Insurance and healthcare service providers often present a variety of health plan options to individuals or employers. An optimal health plan option needs to be selected, based on an individual's needs and preferences. Moreover, the individual may choose between an expensive ‘conventional plan’ and a ‘Health Savings Account (HSA) plan’.

A ‘conventional plan’ is fully funded and has a low deductible health plan option. Numerous products such as Indemnity Plans, Preferred Provider Organizations (PPOs) and Health Maintenance Organizations (HMOs) are readily available as conventional plans.

HSA plan options include a Health Savings Account that is paired with a relatively inexpensive High Deductible Health Plan (HDHP) policy. HSAs were introduced as part of the Medicare Bill, signed into law in December 2003. HSAs allow individuals to combine a tax-advantaged personal savings account with a comprehensive high-deductible insurance policy. Further, HSAs assist in the reduction of healthcare costs. Any unused funds in HSAs accrue over time and can be invested by the account holder.

With the availability of numerous health plan options, it has become necessary for individuals to select an appropriate health plan option from the various options available. A comparison of health plan options is therefore necessary to facilitate optimal health plan selection. Currently available methods compare the gross premium costs of the health plan options. However, with the presence of HSA plans, such comparisons may not be relevant and may not provide enough information regarding the relative value of the plans.

Various matters need to be taken into consideration when a comparison is made between a conventional plan and a HSA plan. Firstly, HSA plans result in employee healthcare expenses that are generally not covered by insurance. Hence, it is difficult to predict these expenses. Further, the information about the levels of these expenses needs to be utilized while deciding on the reasonable value of various health plan options. Secondly, HSAs have the potential to create value for employees, since the unused balance accrues over time and the accounts are portable. This future balance needs to be incorporated into the decision-making process. Thirdly, it is difficult to create an equitable and reasonable employee-premium contribution formula for a high deductible plan. Fourthly, an employer's HSA contribution scheme needs to be structured to make a health plan attractive and financially sustainable.

Hence, there is a need for a simple and standard measure that can be used to evaluate the real value of various health plan options and provide a meaningful comparison of relative health plan values.

### SUMMARY OF THE INVENTION

It is an object of the invention to perform healthcare financial planning for a user.

It is another object of the invention to calculate the net present value of healthcare cash flows.

It is another object of the invention to assist in the comparison of various health plan options.

It is another object of the invention to assist in the selection of an optimal health plan option.

It is another object of the invention to perform financial optimization of various health plan options.

It is another object of the invention to provide the future value of the HSA balances for a selected horizon year.

It is another object of the invention to provide a healthcare retirement planning tool for employees and individual policyholders.

It is another object of the invention to enable employers to optimize their level of contribution to employees' HSA.

The invention presents a method, a system and a computer program product for healthcare financial planning, which is performed for various health plan options, based on the net present value of health plan cash flows. Healthcare financial planning includes comparison, financial optimization and retirement planning for the health plan options. Further, a suitable health plan option may be determined. Healthcare financial planning is performed for a pre-determined period.

Data comprising demographic, financial, health plan, and economic assumption information is used for healthcare financial planning. The data is used to project health plan liabilities for a pre-determined period. These projections are based on known health claim probabilities. Further, health plan liabilities are transformed into health plan costs. The projection and transformation of health plan liabilities are based on age, gender, family dependent status, industry classification and zip code data.

The invention assists an employee, an employer or an individual policyholder to interactively perform healthcare financial planning. An employer may perform healthcare financial planning for all the employees. Various health plan options may be interactively compared on the basis of the net present value (NPV) of healthcare cash flows over the pre-determined period. Healthcare financial planning may be customized, based on end user requirements. A comparison of the NPV for various healthcare options may facilitate the selection of an optimal health plan option. Healthcare financial planning includes financial optimization of healthcare cash flows. Interactive financial optimization may be performed for at least an employee, an employer or an individual policyholder to maximize the NPV of healthcare cash flows and minimize health plan costs. An interactive healthcare retirement planning tool may assist an employee to perform retirement planning. The invention may enable employers to optimize their level of contribution to employees' HSA.

### BRIEF DESCRIPTION OF THE DRAWINGS

The preferred embodiments of the invention will hereinafter be described in conjunction with the appended drawings, provided to illustrate and not to limit the invention, wherein like designations denote like elements, and in which:

FIG. 1 is a block diagram depicting a healthcare financial planning model, in accordance with an embodiment of the invention.

FIG. 2 is a flowchart depicting the process of healthcare financial planning, in accordance with an embodiment of the invention.

FIG. 3a is a flowchart depicting the process of calculation of various factors for an employee, in accordance with an embodiment of the invention.

FIG. 3b is a flowchart depicting the process of calculation of adjusted health claim costs for an employee, in accordance with an embodiment of the invention.

FIG. 3c is a flowchart depicting the process of calculation of the net present value for an employee, in accordance with an embodiment of the invention.

FIG. 4a is a flowchart depicting the process of calculation of HSA contribution upper limit, in accordance with an embodiment of the invention.

FIG. 4b is a flowchart depicting the process of calculation of the net present value for the employer, in accordance with an embodiment of the invention.

FIG. 5 is a block diagram depicting an environment in which various embodiments of the invention may be practiced.

### DESCRIPTION OF PREFERRED EMBODIMENTS

The invention presents a method, a system and a computer program product for healthcare financial planning. The healthcare financial planning is performed for various health plan options based on the net present value of health plan cash flows. Healthcare financial planning includes comparison, financial optimization and retirement planning of health plan options. Further, a suitable health plan option may be determined.

The system may be used by an employee, an employer or an individual policyholder. An employee may perform healthcare financial planning for personal purposes. An employer may perform healthcare financial planning to estimate the healthcare costs of the entire organization. An individual policyholder, other than an employee and an employer, intending to perform healthcare financial planning, is hereinafter referred to as an employee, for the purpose of the invention.

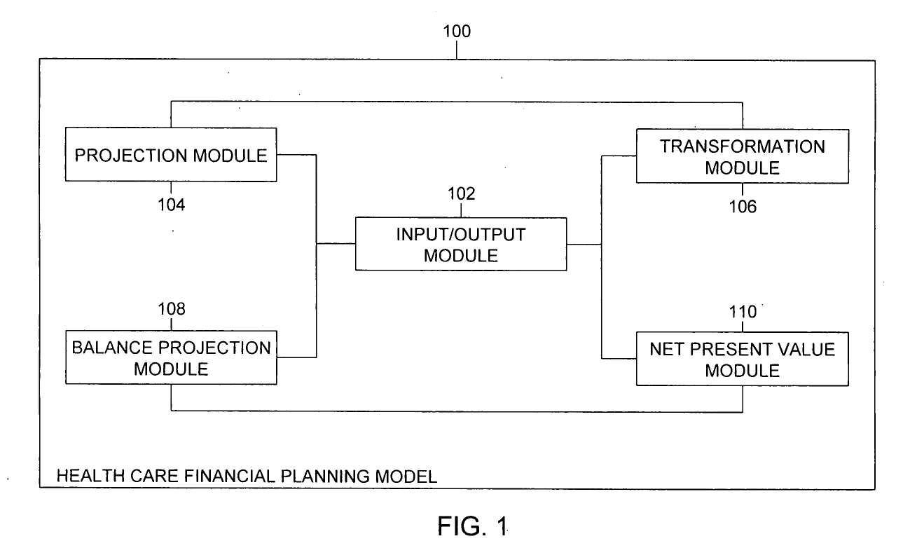

FIG. 1 is a block diagram depicting a healthcare financial planning model 100, in accordance with an embodiment of the invention. Healthcare financial planning model 100 includes an input/output module 102, a projection module 104, a transformation module 106, a balance projection module 108, and a Net Present Value (NPV) module 110.

Input/output module 102 is used to enter data into various data fields of healthcare financial planning model 100. Data entered into healthcare financial planning model 100 includes demographic, financial, health plan and economic assumption information. Data may be entered manually or by the use of automated data entry programs. Input/output module 102 is also used for displaying the results of healthcare financial planning model 100.

Projection module 104 projects health plan liabilities. Distribution of annual health claim probabilities for an employee is utilized to project health plan liabilities. In various embodiments of the invention, health plan liabilities are based on age, gender, family-dependent status, industry classification/SIC code, and zip code.

Transformation module 106 transforms health plan liabilities into health plan costs for various health plan options. Health plan costs may include insurance premiums, out-of-pocket expenses, co-payments, and deductibles. In various embodiments of the invention, health plan costs are based on age, gender, family dependent status, industry classification/SIC code and zip code.

Health plan costs may be calculated on a yearly basis for a pre-determined time period. In an alternative embodiment of the invention, health plan costs may be calculated on a monthly basis for a pre-determined time period. In an embodiment of the invention, the pre-determined time period extends from the current year to a selected horizon year. The current year denotes the start year for healthcare financial planning. The horizon year denotes the year up to which healthcare financial planning may be performed.

Balance projection module 108 projects end-of-year balances for various health plan options. In various embodiments of the invention, end-of-year balances are projected for a Health Savings Account (HSA) paired with a qualified High Deductible Health Plan (HDHP). End-of-year balances are based on HSA contribution and HSA withdrawal in a particular year. In various embodiments of the invention, HSA contribution is the amount contributed to a HSA. HSA withdrawal is the amount withdrawn from the HSA to cover healthcare expenses.

NPV module 110 calculates the NPV of healthcare cash flows. The healthcare cash flows may include health plan costs and end-of-year balances. The NPV is calculated for the pre-determined time period.

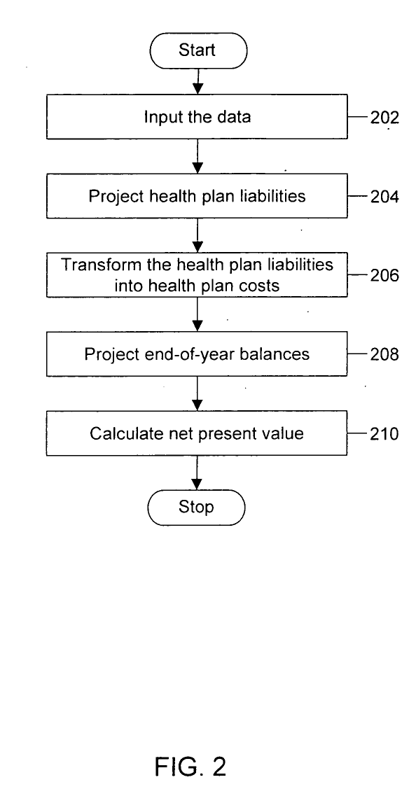

FIG. 2 is a flowchart depicting the process of healthcare financial planning, in accordance with an embodiment of the invention. Healthcare financial planning is performed for various health plan options.

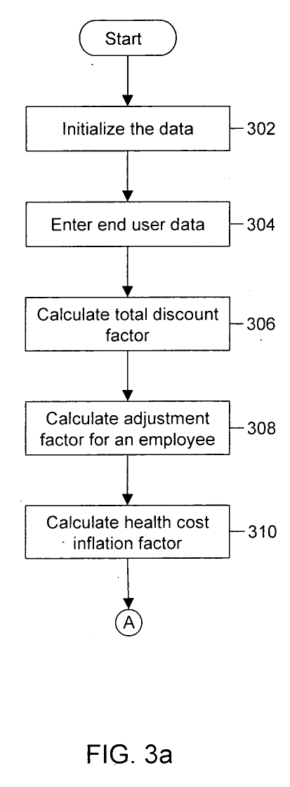

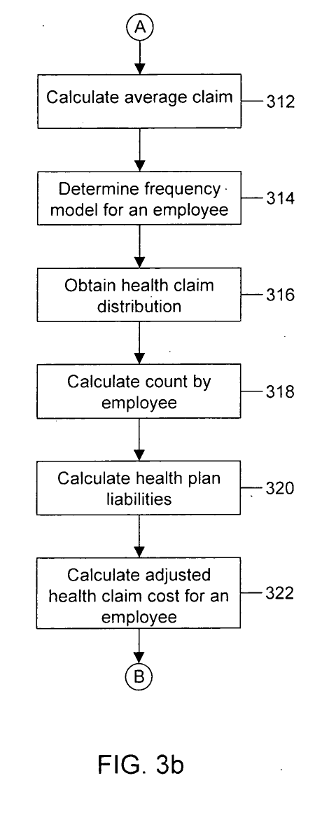

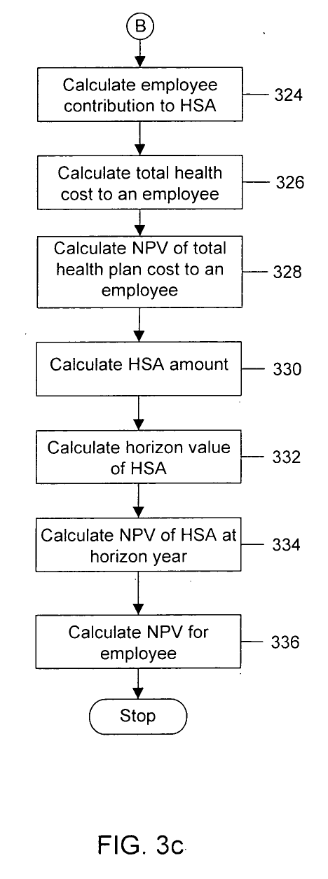

At step 202, data is entered for healthcare financial planning. This data includes initialized information and end user information. The initialized information and end user information are described in detail in conjunction with FIG. 3a.

In an embodiment of the invention, the initialized information may be entered by a programmer, analyst, researcher, end user, and by automated data entry programs. Further, the initialized information may be stored in a memory. The initialized information may be commonly used by various end users, including employees, employers and individuals. End user information may be entered by an end user, an employee, an employer, an external user, and by automated data entry programs.

In an alternative embodiment of the invention, the initialized information may be entered in a manner that is similar to entering end user information.

At step 204, health plan liabilities are projected for various health plan options. Health plan liabilities are used to determine the health plan costs of various health plan options. In various embodiments of the invention, a statistical sampling method is employed to project health plan liabilities. In an embodiment of the invention, the statistical sampling method is a Monte Carlo simulation.

The Monte Carlo simulation may utilize a probability distribution derived from healthcare cost frequency and severity information. In an embodiment of the invention, healthcare cost frequency and severity information may be entered in the form of actuarial data or continuance tables.

At step 206, health plan liabilities are transformed into heath plan costs for various health plan options. Health plan costs may include insurance premiums, out-of-pocket expenses, co-payments and deductibles. Health plan liabilities may be transformed by the use of various factors described in conjunction with FIG. 3b. In various embodiments of the invention, health plan costs are calculated for a pre-determined time period.

At step 208, end-of-year balances are projected for health plan options that include an HSA paired with a qualified HDHP. End-of-year balances are based on HSA contributions and HSA withdrawals in a particular year. In various embodiments of the invention, end-of-year balances are projected for the pre-determined time period.

At step 210, a NPV of healthcare cash flows is calculated. These healthcare cash flows may include health plan costs and end-of-year balances. In various embodiments of the invention, the NPV is calculated for the pre-determined time period.

FIG. 3a is a flowchart depicting the process of calculation of various factors for an employee, in accordance with an embodiment of the invention. The factors that need to be calculated include the total discount factor, the adjustment factor and the health cost inflation factor. These factors are utilized to calculate the adjusted health claim cost for an employee. The input data is utilized to calculate these factors.

In various embodiments of the invention, the input data includes demographic, financial, health planning and economic assumption information. Some portion of the input data may be initialized; the remaining input data is entered by an end user.

At step 302, initialized information is entered. In an embodiment of the invention, economic assumption information is initialized. Economic assumption may be initialized in advance and shielded from the end user. In an embodiment of the invention, the initialized information may be updated whenever required.

In an embodiment of the invention, economic assumption information includes the interest rate of return on invested HSA balances, the interest rates for present value calculations, the healthcare cost inflation rate, the general rate of inflation (CPI), the CPI growth rate, the projected rate of growth of GDP in the United States, employee growth, attrition rates for employer-sponsored plans, the rate of aging in the employee base for employer-sponsored plans, managed care discounts, behavioral incentive discounts, maximum allowable HSA contribution, based on dependent status and current US Treasury guidelines, maximum allowable catch-up contribution amounts based on end user's age, and maximum allowable first year HSA contribution based on end users' effective date of coverage.

In an embodiment of the invention, multiple sets of economic assumption information may be entered. Each set of economic assumption information relates to an economic scenario for which healthcare financial planning may be performed. During data entry, a user may opt for at least one of the available economic scenario options. In an embodiment of the invention, three scenarios may be provided: low, medium or high.

In an embodiment of the invention, the initialized information is checked for validity. An error message is thereby displayed on an interface for each instance of an invalid data entry.

At step 304, end user information is entered. In an embodiment of the invention, the end user information includes demographic, financial and health plan information.

In an embodiment of the invention, the demographic information is entered for an employee. The demographic information includes the name, identification number, gender, year of birth, health insurance plan dependent status, zip code, SIC code, date of initial eligibility, retirement date and horizon year. In an embodiment of the invention, an option for selecting a tier status is provided. The tier status option may be selected from a two-tier status and a four-tier status. The two-tier status includes the options of ‘single’ and ‘married’. The four-tier status includes the options of ‘employee single’, ‘employee with spouse’, ‘employee with children’ and ‘employee with family’.

In an embodiment of the invention, the financial information includes the marginal tax rate, the discount rate, healthcare cost frequency, severity information via actuarial data or continuance tables, the total Health Savings Account (HSA) contribution amount, the employee HSA contribution amount, the employer HSA contribution amount, HSA contribution amounts from other sources, gross monthly health plan premiums, employee contribution to health plan premiums, and HSA catch-up contributions.

In an embodiment of the invention, the health plan information includes the health plan name, the health plan type, the deductible amount, the out-of-pocket maximum amount, the coinsurance percentage, the average co-pay amount, the current health plan monthly premiums, and alternative health plan(s) monthly premiums. In various embodiments of the invention, the deductible amount, the out-of-pocket maximum amount, current health plan monthly premiums, and alternative health plan(s) monthly premiums are based on the health plan dependent status.

In an embodiment of the invention, the end user information is checked for validity. An error message is thereby displayed on an interface for each instance of an invalid data entry.

At step 306, a total discount factor, DiscT, is calculated. DiscT is based on a managed care discount, DiscM, and a HSA behavioral discount, DiscB, whenever applicable. The DiscM represents the reduction percentage in healthcare costs due to managed care. The DiscB represents the reduction percentage in healthcare costs due to incentives being paid from an HSA. In an embodiment of the invention, the DiscB is zero for non-HSA plans. In an embodiment of the invention, DiscT is calculated by using the following equation:
DiscT=1−DiscM−DiscB 1

In an embodiment of the invention, the total discount factor may be input by a user in the form of an initialized input.

At step 308, the adjustment factor for an employee may be calculated. The adjustment factor for an employee is equal to the product of the age-gender factor, the SIC code factor and the zip code factor. The adjustment factor is used to calculate the adjusted health claim cost for an employee, as explained in conjunction with FIG. 3b.

In an embodiment of the invention, factor tables for age-gender, SIC code and zip code are entered during end user information entry. Factor tables include various factors to be used for customization of health plan costs for all employees. The age-gender factor is based on the age and gender of an employee. The SIC code factor is based on the SIC code of the employer. The zip code factor is based on the zip code of an employee. In an alternative embodiment of the invention, the zip code factor is based on the zip code of the employer.

At step 310, a health cost inflation factor, HIF, is calculated. The HIF is based on a maximum-limit year. The maximum-limit year is the year in which US healthcare costs, as a percent of US GDP, reach the maximum limit. This maximum-limit year is based on yearly US healthcare costs as a percent of its GDP and YrHC. The YrHC may be calculated for each year in the pre-determined time period. YrHC are based on the healthcare inflation rate, the hci, current year US healthcare costs as a percent of GDP, the CurHC, and the GDP multiplier, g. In an embodiment of the invention, YrHC are calculated by using the following equation:
YrHC=(1+hci)* CurHC/g 2
where, g is based on the real annual percentage growth in the GDP of the US, the GroGDP, the CPI annual increase rate, the GroCPI, and the years from the current year, t. GroGDP is the GDP growth rate averaged over the long term and pre-adjusted for inflation. The GDP multiplier, g, may be calculated for a pre-determined time period by using the following equation:
g=((1+GroGDP)*(1+GroCPI))ˆ 3

For example, if the current year is 2006 (t=1) and horizon year is 2008 (t=3), g is calculated for all the years ranging from the current year to the horizon year.

In an embodiment of the invention, the GDP multiplier may be entered in the form of an initialized input.

Yearly healthcare costs, YrHC, are compared with the maximum limit of US healthcare costs as a percent of GDP, to find the maximum-limit year. In various embodiments of the invention, the healthcare cost inflation rate, the GDP growth rate and the general rate of inflation may be assumed to be constant.

In an embodiment of the invention, the yearly health cost inflation factor, HIF, is calculated for the pre-determined time period. The HIF is equal to one for the current year. For the years following the current year and before the maximum-limit year, the HIF is equal to the healthcare inflation rate plus one (hci+1). For the years till the horizon year, the HIF may be calculated by using the following equation:
HIF=(1+GroGDP)*(1+GroCPI)) 4

In an alternative embodiment of the invention, the HIF may be entered in the form of an initialized input.

FIG. 3b is a flowchart depicting the process of calculation of the adjusted health claim cost for an employee, in accordance with an embodiment of the invention. The adjusted health claim cost for an employee is used to calculate the total health cost for the employee.

At step 312, an average claim is calculated. The average claim is the average claim cost covered by a particular cost range and is calculated by taking an average of the cost range and expense. Expense is the minimum expenditure corresponding to a particular cost range. The value of the expense may be entered during end user information entry.

At step 314, a frequency model for an employee is determined for statistical sampling. The frequency model is based on health cost frequency and severity information. In an embodiment of the invention, the frequency model for an employee is selected on the basis of the employee zip code. In an alternative embodiment of the invention, the frequency model for an employee is selected on the basis of a company zip code. In various embodiments of the invention, the zip codes are used to identify the geographical location, based on which the frequency model is determined. In an embodiment of the invention, four frequency models are available. These four frequency models correspond to four geographies, i.e., Southern California, New York, West Coast and the rest of the United States.

At step 316, health claim distribution is obtained for an employee. Health claim distribution reflects the distribution of annual health claim probabilities for the employee. The calculated average claim and the selected frequency model are utilized to generate an appropriate health claim distribution for the employee.

In an embodiment of the invention, the claim distributions may be generated by employing a statistical sampling method. In an embodiment of the invention, the statistical sampling method may be a Monte Carlo simulation.

Monte Carlo simulation is a computerized technique that forms the basis for probabilistic risk analysis. The simulation may be used to replicate real life occurrences by mathematically modeling a projected event. Monte Carlo simulation may use a pre-defined probability distribution of risk variables to perform random modeling over many simulations or computer trials. The results are probabilistic and are utilized to yield a minimum value, a maximum value, an expected value (mean), a median value and a standard deviation. The results may also be utilized in the preparation of probability bands charts, probability density charts and cumulative probabilities charts. The cumulative probabilities express the total likelihood (probability) at any level of variable outcome.

In an embodiment of the invention, Monte Carlo simulation may be used to represent or model individuals in a population with ranges of values for certain health characteristics or outcomes. In some cases, random components may be added to the values of a known input variable, for the purpose of determining the effects of fluctuations of this variable on the values of the output variable.

In an embodiment of the invention, approximately 1000 simulations or computer trials may be performed to compute the expected value (mean) of probabilities or health claim costs.

In an embodiment of the invention, the Monte Carlo simulation is performed for the pre-determined time interval.

In an embodiment of the invention, the Monte Carlo simulation may be implemented to simulate healthcare utilization for an employee. The simulation may be customized for each employee and is based on age, gender, family-dependent status, home zip code and industry classification/SIC code. The simulated liabilities may be adjusted and shown on a probabilistic basis within the context of health plan designs. The employee results may be aggregated if the individuals are part of an employer sponsored plan.

At step 318, a count by employee is calculated. The count by employee is a weighted number of people associated with the employee. In an embodiment of the invention, the count by employee is based on the family dependent status of the employee

If the selected tier status is a four-tier status, the count by employee is calculated as follows. If the family status is ‘employee single’, the count by employee is equal to one. If the family status is ‘employee with spouse’, the count by employee is equal to 2. If the family status is ‘employee with children’, the count by employee is equal to 2.5, and if the family status is ‘employee with family’, the count by employee is equal to 3.5.

If the selected tier status is a two-tier status, the count by employee is calculated as follows. If the family status is ‘single’, the count by employee is equal to 1. If the family status is ‘married’, the count by employee is equal to 2.

At step 320, health plan liabilities for an employee are calculated. These health plan liabilities are obtained by the multiplication of the count by employee and the health claim distribution for the employee. In various embodiments of the invention, the health liabilities for an employee are calculated for the pre-determined interval.

At step 322, the adjusted health claim cost for an employee is calculated. In an embodiment of the invention, the adjusted claim cost for an employee is equal to the product of the health plan liabilities for an employee, the adjustment factor for an employee (calculated at step 308), the health cost inflation factor by year (calculated at step 310), the total discount factor (calculated at step 306), and the year utilization percent.

In an embodiment of the invention, healthcare financial planning may be performed after some time has elapsed from the beginning of the calendar year. An employee would be able to contribute to HSA only for the time remaining in the calendar year. The percentage of contribution an employee makes for the remaining part of the year is known as the year utilization percent. For example, an employee establishes an HDHP on July 1 in a current year. This health plan will be effective for the remaining six months of the current year. The employee would be able to contribute only 50 percent to the HSA for the current year. In this case, the year utilization percent is set at 50 percent for the employee. For years other than the current year, the year utilization percent is equal to 100 percent.

The adjusted health claim cost for an employee is used to calculate the out-of-pocket cost for an employee, as described in conjunction with FIG. 3c.

FIG. 3c is a flowchart depicting the process of calculation of the NPV for an employee.

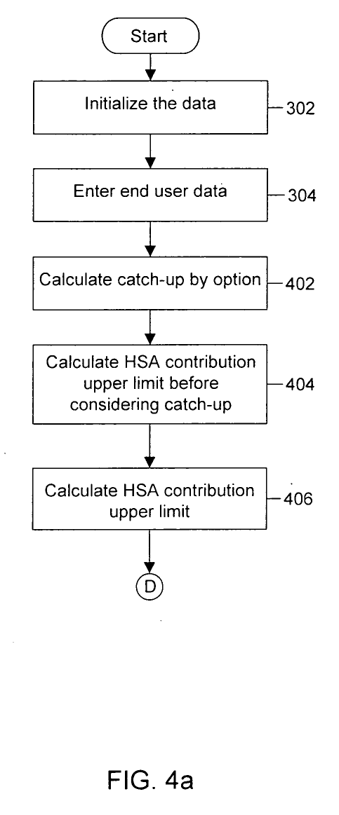

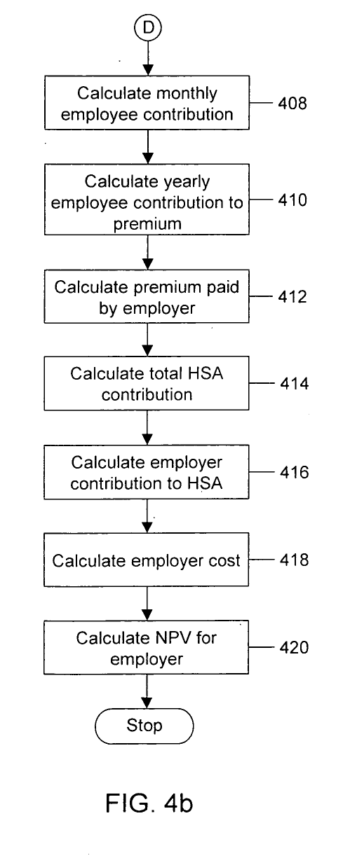

At step 324, the employee contribution to the HSA, eeHSAC, is calculated. The eeHSAC is equal to the difference of the total HSA contribution and the employer contribution to the HSA, erHSA. The process of obtaining the total HAS contribution and the employer contribution to HSA will be described in detail at steps 414 and 416 in FIG. 4b.

At step 326, the total health plan cost to an employee, TCI, is calculated. The TCI t is calculated for a pre-determined time period. The TCI is based on the HSA withdrawal, the HSAW, the out-of-pocket cost, the OOP, the yearly employee contribution to the premium, the CPE, the employee contribution to the HSA, the eeHSA, and the marginal tax rate, TaxRate. In an embodiment of the invention, the TCI may be calculated by using the following equation:
TCI=(CPE+eeHSAC)*(1−TaxRate)+(OOP−HSAW) 4

The HSA withdrawal is the amount withdrawn from the HSA account to cover out-of-pocket costs for a particular year. In various embodiments of the invention, out-of-pocket costs cannot be greater than the amount present in the HSA account.

Out-of-pocket costs are based on the maximum out-of-pocket inflated amount, OOPmax, the adjusted health claim cost by employee, the adjCee, the deductible inflated, the Ded, the coinsurance rate, the CoR, and the adjusted co-pay by employee, adjCop.

$$\begin{matrix}OOP = Min ( [ OOP max I , Min ( [ adjCee , DedI ] ) + \\ Max ( [ 0 , ( adjCee - DedI ) * CoR ] ) + adjCop\end{matrix} \qquad 6$$

The maximum out-of-pocket inflated amount, OOPmaxI, is equal to the product of the maximum out-of-pocket amount, OOPmax and the CPI factor, CPIF. In various embodiments of the invention, OOPmax may be entered in the form of an end user input. The CPI factor, CPIF, is calculated for the pre-determined time period. The CPIF is based on the CPI annual increase rate, CPIinc, and the years from the current year, t, and is given by the following equation:
CPIF=(1+CPlinc)ˆt 7

The adjusted health claim cost by employee is calculated at step 322 in FIG. 3b. The deductible inflated, DedI, is equal to the product of the deductible and CPI factor, CPIF. The coinsurance percentage is entered as an input as a part of health plan information, as described in conjunction with FIG. 3a.

The adjusted co-pay by employee, adjCop, is equal to the product of the employee co-pay amount, the adjustment factor (calculated at step 308 in FIG. 3a), the healthcare inflation rate (calculated at step 310 in FIG. 3a), and the total discount factor (calculated at step 306 in FIG. 3a). The employee co-pay amount is the total co-payment towards office visits per employee, summed over dependents. The employee co-pay amount is equal to the product of the co-pay per year, the co-pay amount and the count by employee, as calculated at step 318 in FIG. 3b. The co-pay per year is the probability distribution over the number of office visits per year. In various embodiments of the invention, the co-pay per year is based on the deductible, depending on whether the employee has a high or low-deductible plan. The co-pay amount is to be paid by the employee per office visit.

At step 328, the NPV of the total health plan cost to an employee is calculated. The NPV of total health plan cost is calculated by discounting the yearly total health plan costs by a pre-determined discount rate for a pre-determined time period. In an embodiment of the invention, the pre-determined discount rate is equal to the rate of return on a 10-year US Treasury bill.

At step 330, the HSA amount is calculated. The HSA amount is the end-of-year balance amount in an employee's HSA. At the end of each year, the end-of-year balance is the end-of-year balance amount from the previous year, increased by the interest earned over the year (zero in the first year), plus the difference of the HSA contribution and the HSA withdrawals during that particular year, multiplied by the square root of (1+annual rate of interest). The square root implies that the HSA contributions and the HSA withdrawals take place midyear and earn an interest only for six months. This is an approximate representation of the contributions and withdrawals that are distributed uniformly throughout the year.

At step 332, the horizon value of the HSA is calculated. The horizon value of the HSA is the end-of-year balance amount in the HSA in the horizon year. In an embodiment of the invention, horizon value of the HSA may be used to find the HSA amount at the retirement year. The HSA amount at the retirement year is based on the annual rate of interest, the horizon value of the HSA, the retirement year, and the horizon year. The HSA amount at the retirement year is given by the following equation:
retHSA=horizHSA*(1+r)ˆ(retYr−horizYr) 8

At step 334, the NPV of the HSA at the horizon year is calculated. The NPV of the HSA at the horizon year is calculated by discounting the horizon value of the HSA at a pre-determined discount rate for a pre-determined time period. In an embodiment of the invention, the pre-determined discount rate is equal to the rate of return on a 10-year US Treasury bill.

At step 336, the NPV for the employee is calculated. The NPV for an employee is the difference between the NPV of the HSA at the horizon year and the NPV of the total health plan cost to an employee.

FIG. 4a is a flowchart depicting the process of calculation of the HSA contribution upper limit, in accordance with an embodiment of the invention. The HSA contribution upper limit is used to obtain the actual HSA contribution to be made by the employee and the employer. Steps 302 and 304 are the same as those described above with respect to FIG. 3a.

At step 402, catch-up by option is calculated. In various embodiments of the invention, eligible employees have the option of making catch-up contributions. Catch-up by option, for employees opting for catch-up contributions, is equal to the catch-up amount for an employee. The catch-up by option for other employees is equal to zero.

The provision for the catch-up amount, applicable for aged employees, has been provided by US law. In an embodiment of the invention, employees at and above the age of 55 may make enhanced contributions to the HSA every year. Starting in 2004, an additional contribution of $500 is allowed to an employee, increasing by $100 per year, till it reaches $1,000 per year in 2009, remaining constant thereafter. In various embodiments of the invention, the catch-up amount for an employee is calculated for the pre-determined interval. For employees below the age of 55, the catch-up amount is equal to zero.

In an embodiment of the invention, the criteria for the catch-up amount for an employee may be modified, based on the prevailing legislation.

At step 404, the HSA contribution upper limit (before considering catch-up) is calculated for an employee. The HSA contribution upper limit (before considering catch-up) is calculated by finding the maximum amount that may be annually contributed to an employee HSA. The HSA contribution upper limit (before considering catch-up) is calculated by multiplying the CPI factor with the deductible or the upper limit of annual HSA contribution, whichever is less. The upper limit on annual HSA contribution is taken in the form of end user input.

In various embodiments of the invention, the HSA contribution upper limit for an employee, before considering catch-up, is calculated for the pre-determined time period.

At step 406, the HSA contribution upper limit is calculated for the pre-determined time period. In an embodiment of the invention, the HSA contribution upper limit is calculated by multiplying the eligibility percent with the sum of the HSA contribution upper limit (before considering catch-up) and catch-up by option. The eligibility percent is the percentage of time for the pre-determined time period when an employee is eligible to make HSA contributions. In an embodiment of the invention, the eligibility percent may be equal to 100 percent.

The HSA contribution upper limit is used to obtain the total HSA contribution, as described in conjunction with FIG. 4b.

FIG. 4b is a flowchart depicting the process of calculation of the NPV for the employer.

At step 408, the monthly employee contribution to the premium, eeC, is calculated. In various embodiments of the invention, the eeC is calculated for the current year. The eeC is based on employee premium contribution, eePre, and the total monthly premium, TP. In an embodiment of the invention, employee premium contribution, eePre, may be input as a percentage. Monthly employee contribution, eeC, may be calculated by using the following equation:
eeC=TP*(eePre/100 9

The total monthly premium, TP, is the monthly premium for various health plan options for an employee. In an embodiment of the invention, the TP is the total employee-specific premium obtained from the employee data table. The total employee-specific premium is the monthly premium per employee, paid for current plan(s) and the HSA plan, whenever premium is employee-specific. The employee data table includes demographic information, as described in conjunction with FIG. 3a.

If the total employee-specific premium is equal to zero, the TP is equal to the composite premium obtained from the entered plan data. The composite premium is the monthly composite premium, based on the plan type and the family-dependent status. The plan data includes health plan information, as described in conjunction with FIG. 3a.

In an alternative embodiment of the invention, the employee premium contribution, eePre, may be input in the form of an amount. Thereby, the monthly employee contribution to the premium becomes equal to the employee premium contribution.

The monthly employee contribution to the premium may be used to calculate the current year employee contribution. The current year employee contribution is equal to 12 times the monthly employee contribution to the premium.

At step 410, the yearly employee contribution to the premium, CPE, is calculated. In various embodiments of the invention, the CPE is calculated for the pre-determined time period. The CPE is the annual payment made by an employee towards the premium, as an amount or a percent of the premium. The yearly employee contribution to the premium is equal to the product of the current year employee contribution and the health cost inflation factor. Health cost inflation factor is calculated at step 310 in FIG. 3a.

At step 412, the premium paid by the employer, PPE, is calculated. The PPE is computed as the difference of the total yearly premium (TYP) and the yearly employee contribution to the premium, CPE, summed over all the employees. The TYP is equal to the product of the current year's total yearly premium and the health cost inflation factor. The current year's total yearly premium is equal to 12 times the total monthly premium, TP. In various embodiments of the invention, the PPE is calculated for the pre-determined time period.

At step 414, the total HSA contribution is calculated. The total HSA contribution is based on the insured HSA contribution. The insured HSA contribution is entered in the form of an initialized input. The total HSA contribution is equal to the minimum of insured HSA contribution and HSA contribution upper limit. In an alternative embodiment of the invention, the insured HSA contribution may be selected as ‘maximum’. In this case, the total HSA contribution is equal to the HSA contribution upper limit. In an alternative embodiment of the invention, the insured HSA contribution may be selected from a list of options. The list of options includes different HSA contribution amounts. In this case, the total HSA contribution is equal to the lesser of the insured HSA contribution and the HSA contribution upper limit.

At step 416, the employer contribution to the HSA and the erHSA is calculated. The erHSA is the annual contribution to the HSA by the employer and is based on proposed employer contribution to the HSA. In an embodiment of the invention, the proposed employer contribution to HSA is entered as an amount. In this case, the employer contribution to the HSA is equal to the proposed employer contribution to the HSA. In an alternative embodiment of the invention, the proposed employer contribution to the HSA is entered as a percentage. In this case, the employer contribution to the HSA is equal to the product of the proposed employer contribution to the HSA and the total HSA contribution. In various embodiments of the invention, the employer contribution to the HSA is calculated for the current year.

At step 418, the employer cost, erC, is calculated. The erC is based on the premium paid by the employer, PPE, the employer HSA contribution, the erHSA, the staff growth rate, the SGR, and the years from the current year, t. The employer cost, erC, may be computed by using the following equation:

$$erC = [ PPE + {\sum }_{1}^{NumberofEmployees} erHSA ] * ( 1 + SGR ) \hat{} t \qquad 10$$

At step 420, the NPV for the employer is calculated. The NPV for the employer is calculated by discounting yearly employer costs by a pre-determined discount rate for a pre-determined time period. In an embodiment of the invention, the pre-determined discount rate is equal to the rate of return on a 10-year US Treasury bill.

The invention presents a system, a method and a computer program product that provides numerous advantages to the end users. In an embodiment of the invention, future healthcare utilization, based on a known healthcare probability distribution, is simulated in order to facilitate the selection of a desired health plan option. An end user may compare the selected health plan option by interactively comparing the intrinsic values of the selected health plan options. The comparison may be useful in case at least one of the selected health plan options includes a Health Saving Account (HSA) and a qualified High Deductible Health Plan (HDHP).

In an embodiment of the invention, financial optimization for group health insurance policyholders may be performed. The optimization may be an interactive feature that balances two objectives simultaneously. The first objective may be to maximize the NPV of simulated healthcare cash flows over the pre-determined time period for an employee. The second objective may be to minimize the NPV of the projected health plan-related cash flows over the pre-determined time period for an employer. An iterative algorithm may be implemented to achieve the above-mentioned objective. In case the second objective is defined as a fixed budget, there may be a need to maximize only the first objective. The input data may represent the constraints present while attempting to meet the objectives simultaneously.

In an alternative embodiment of the invention, an interactive financial optimization feature may be provided for an employee or an individual policyholder.

In an embodiment of the invention, an interactive feature may provide individuals with the future value of their HSA balances at a selected horizon year. The interactive feature may include presenting the results in the form of probability bands. This feature can be used as a financial planning tool enabling participants to determine the likelihood of meeting future healthcare funding objectives.

In an embodiment of the invention, an interactive feature may be provided as a healthcare retirement planning tool for employees and individual policyholders. The feature may provide asset/liability matching capabilities, which show funding shortfalls or surpluses at selected retirement dates. The results may present users with the difference between the future value of HSA balances at a selected horizon year and the present value of projected out-of-pocket liabilities at the retirement year. The net result of this healthcare retirement planning tool is a single number revealing the surplus or deficit.

In an embodiment of the invention, an interactive feature may be provided to enable employers to optimize the level of contribution to employees' HSA. End users may enter a fixed dollar or percentage HSA contribution level and view the impact of that selected contribution in light of key output features such as health plan costs, the NPV of cash flows, etc. For example, an employer is able to view comparative plan costs over the pre-determined time period in the context of various HSA contribution levels.

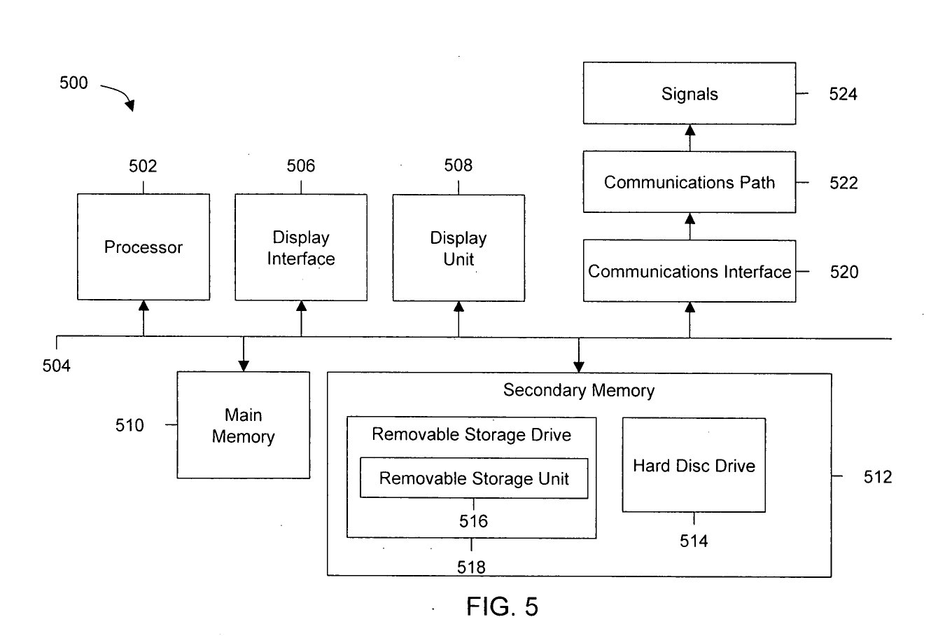

FIG. 5 is a diagram of an environment in which various embodiments of the invention may be practiced. The invention may be implemented by using hardware, software, or a combination thereof, and may be implemented in one or more computer systems or other processing systems. Useful machines for performing the operation of the invention include general purpose digital computers or similar devices. Computer system 500 may be used for implementing the invention.

Computer system 500 includes one or more processors, such as processor 502. Processor 502 is connected to a communication infrastructure 504, e.g., a communication bus, a cross-over bar, or a network. Various software embodiments are described in terms of this exemplary computer system. After reading this description, it will become apparent to a person skilled in the relevant art(s) how to implement the invention by using other computer systems and/or architectures.

Computer system 500 can include a display interface 506 that forwards graphics, text and other data from communication infrastructure 504 (or from a frame buffer not shown) for display on a display unit 508.

Computer system 500 also includes a main memory 510, preferably a random access memory (RAM), and may also include a secondary memory 512. Secondary memory 512 may include, for example, a hard disk drive 514 and/or a removable storage drive 516 representing a floppy disk drive, a magnetic tape drive, an optical disk drive, etc. Removable storage drive 516 reads from and/or writes to a removable storage unit 518 in a well-known manner. Removable storage unit 518 represents a floppy disk, a magnetic tape, an optical disk, etc., which is read by and written to by removable storage drive 516. As will be appreciated, removable storage unit 518 includes a computer-usable storage medium having stored therein computer software and/or data.

In alternative embodiments, secondary memory 512 may include other similar devices for allowing computer programs or other instructions to be loaded into computer system 500. Such devices may include, for example, a removable storage unit and an interface. Examples of such may include a program cartridge and a cartridge interface (such as that found in video game devices), a removable memory chip (such as an erasable programmable read only memory (EPROM), or a programmable read only memory (PROM)) and an associated socket, and other removable storage units and interfaces, which allow software and data to be transferred from the removable storage unit to computer system 500.

Computer system 500 may also include a communications interface 520. Communications interface 520 allows software and data to be transferred between computer system 500 and external devices. Examples of communications interface 520 may include a modem, a network interface (such as an Ethernet card), a communications port, a Personal Computer Memory Card International Association (PCMCIA) slot and card, etc. Software and data transferred via communications interface 520 are in the form of signals 524, which may be electronic, electromagnetic, optical or other signals capable of being received by communications interface 520. These signals 524 are provided to communications interface 520 via a communications path, e.g., channel 522. This communications path 522 carries signals 524 and may be implemented by using wire or cable, fiber optics, a telephone line, a cellular link, an radio frequency (RF) link, and other communications channels.

In this document, the terms ‘computer program medium’ and ‘computer-usable medium’ are used to generally refer to media such as removable storage drive 516, a hard disk installed in hard disk drive 514, and signals 524. These computer program products provide software to computer system 500. The invention is directed to such computer program products.

Computer programs (also referred to as computer control logic) are stored in main memory 510 and/or secondary memory 512. Computer programs may also be received via communications interface 520. Such computer programs, when executed, enable computer system 500 to perform the features of the invention, as discussed herein. In particular, the computer programs, when executed, enable processor 502 to perform the features of the invention. Accordingly, such computer programs represent controllers of computer system 500.

In an embodiment, where the invention is implemented by using software, the software may be stored in a computer program product and loaded into computer system 500 by using removable storage drive 516, hard disk drive 514 or communications interface 520. The control logic (software), when executed by processor 502, causes processor 502 to perform the functions of the invention, as described herein.

The manual data entry screens may be implemented by, for example, tables, spreadsheets and any other suitable means.

In another embodiment, the invention is implemented primarily in the hardware by using, for example, hardware components such as application-specific integrated circuits (ASICs). Implementation of the hardware state machine, so as to perform the functions described herein, will be apparent to persons skilled in the relevant art(s).

In yet another embodiment, the invention is implemented by using a combination of both hardware and software.

While the preferred embodiments of the invention have been illustrated and described, it will be clear that the invention is not limited to these embodiments only. Numerous modifications, changes, variations, substitutions and equivalents will be apparent to those skilled in the art, without departing from the spirit and scope of the invention, as described in the claims.

What is claimed is:

1. A method for healthcare financial planning, the healthcare financial planning being performed for a plurality of health plan options, the method comprising the steps of:
inputting data, the input data being representative of at least one of demographic information, financial information, health plan information and economic assumption information;
projecting health plan liabilities based on the input data, the health plan liabilities being projected for the plurality of health plan options, the projections being performed for a pre-determined time period; and
transforming the health plan liabilities into health plan costs for the plurality of health plan options.

2. The method according to claim 1 further comprising the step of projecting end-of-year balances, the end-of-year balances being projected for at least one of the plurality of health plan options.

3. The method according to claim 2, wherein the at least one of the plurality of health plan options comprises Health Savings Account (HSA) plan and High Deductible Health Plan (HDHP).

4. The method according to claim 1 further comprising the step of calculating a net present value of end-of-year balances.

5. The method according to claim 1 further comprising the step of calculating a net present value of the health plan costs.

6. The method according to claim 1 further comprising the step of calculating a cumulative net present value of the health plan costs.

7. The method according to claim 1, wherein the input data comprises initialized information, the information being initialized by a user.

8. The method according to claim 1, wherein the input data comprises end user information, the end user information provided by a user.

9. The method according to claim 1, wherein projecting health plan liabilities comprises employing a statistical sampling method.

10. The method according to claim 9, wherein the statistical sampling method is a Monte Carlo simulation.

11. The method according to claim 1, wherein the projections of the health plan liabilities is based on at least one of age, gender, family dependent status, industry classification and zip code data.

12. The method according to claim 1, wherein the transformations of the health plan liabilities are based on at least one of age, gender, family dependent status, industry classification and zip code data.

13. The method according to claim 1, wherein health plan costs comprises at least one of health plan out-of-pocket costs and health plan insurance premiums.

14. A system for healthcare financial planning, the healthcare financial planning being performed for a plurality of health plan options, the system comprising:
an input/output module, the input/output module receiving data representative of at least one of demographic information, financial information, health planning information and economic assumption information;
a projection module, the projection module projecting health plan liabilities based on the input data, the health plan liabilities being projected for the plurality of health plan options; and
a transformation module, the transformation module transforming the health plan liabilities into health plan costs for the plurality of health plan options.

15. The system according to claim 14 further comprising a balance projection module, the balance projection module projecting end-of-year balances for at least one of the plurality of health plan options.

16. The system according to claim 14 further comprising a net present value module, the net present value module calculating the net present value of at least one of health plan costs and end-of-year balances.

17. The system according to claim 14, wherein the projection module employs a statistical sampling method.

18. The system according to claim 14, wherein the health plan costs comprises at least one of health plan out-of-pocket costs and health plan insurance premiums.

19. A computer program product for use with a stored program computer, the computer program product comprising a computer usable medium having a computer readable program code embodied therein for healthcare financial planning, the healthcare financial planning being performed for a plurality of health plan options, the computer program code performing the following functions:
inputting data, the input data being representative of at least one of demographic information, financial information, health planning information and economic assumption information;
projecting health plan liabilities based on the input data, the health plan liabilities being projected for the plurality of health plan options; and
transforming the health plan liabilities into health plan costs for the plurality of health plan options.

20. The computer program product according to claim 19, wherein the computer program code further performs projecting end-of-year balances, the end-of-year balances being projected for at least one of the plurality of health plan options.

21. The computer program product according to claim 19, wherein the computer program code further performs calculating a net present value of end-of-year balances.

22. The computer program product according to claim 19, wherein the computer program code further performs calculating a net present value of the health plan costs.

23. The computer program product according to claim 19, wherein the computer program code further performs calculating a cumulative net present value of the health plan costs.
